(19) United States
(12) Patent Application Publication
(10) Pub. No.: US 2024/0393775 A1
(43) Pub. Date: Nov. 28, 2024

(54) DETERMINING ANOMALOUS EVENTS IN A SYSTEM USING A BLOOM FILTER

(71) Applicant: EATON INTELLIGENT POWER LIMITED, Dublin (IE)

(72) Inventors: Daniel ZUCCHETTO, Dublin (IE); Keith NOLAN, Westmeath (IE)

(21) Appl. No.: 18/694,648

(22) PCT Filed: Nov. 24, 2021
(86) PCT No.: PCT/EP2021/082900

§ 371 Date: Mar. 22, 2024

(51) Int. Cl. G05B 23/02

(52) U.S. Cl. CPC G05B 23/0221; G05B 23/027

(57) ABSTRACT

Some embodiments relate to computer-implemented method for determining an anomalous event in a system. The invention includes defining a Bloom filter representing predefined signature strings each indicative of an anomalous event in the system. The invention includes receiving sensor data from, sensors of the system, indicative of operational parameters associated with the system. The invention includes determining, based on the sensor data, a current signature string indicative of current operation of the system, and comparing the current signature string to the predefined signature strings to determine whether there is an anomalous event in the system, where performing the comparison includes applying the Bloom filter to the current signature string.

### CROSS-REFERENCE TO RELATED APPLICATIONS

This application is a national phase filing under 35 C.F.R. § 371 of and claims priority to PCT Patent Application No. PCT/EP2021/082900, filed on Nov. 24, 2021.

### TECHNICAL FIELD

The invention relates to determining an anomalous event in a system. In particular, the invention relates to comparing received sensor data associated with the system to data indicative of predefined anomalous events in the system by means of a Bloom filter.

### BACKGROUND

It is important to be able to detect anomalies in the operation of a system of electrical or other industrial equipment, e.g. pumps, controllers, switchgear, circuit breakers, etc. This is because anomalies may indicate that part of the system is malfunctioning, or indicate that imminent failure of some or all of the system is likely. Operational anomalies in a system may be detected via sensor data associated with the system, for instance.

Timely and reliable detection of anomalies in such a system is crucial. Such detection can allow for developing issues in the system to be addressed prior to one or more system components failing, and/or can allow for relevant, affected parts of the system to be isolated—and possibly shut down—prior to an issue spreading more widely across different parts of the system.

One challenge in providing suitable anomaly detection is the speed at which anomalies need to be detected and acted upon. Certain systems may require relatively fast detection and action times, e.g. of the order of milliseconds, in order to limit the effects of developing issues or to prevent system failures. Some known methods for anomaly detection—e.g. genetic algorithms, principal component analysis—are unsuitable in such cases as their processing or execution times are greater than the required detection and action times.

It is also the case that in a system that provides critical services, the time during which these services are not available must be minimised. Any approach for detecting and managing possible faults in such a system must therefore only stop or reduce operation of part or all of the system if it is completely necessary.

It is against this background to which the present invention is set.

### SUMMARY OF THE INVENTION

According to an aspect of the present invention there is provided a computer-implemented method for determining an anomalous event in a system. The method may comprise defining a Bloom filter representing a plurality of predefined signatures each comprising a string of values and each being indicative of an anomalous event in the system. The method may comprise receiving sensor data, from a plurality of sensors of the system, indicative of a plurality of operational parameters associated with the system. The method may comprise determining, based on the received sensor data, a current signature comprising a string of values and being indicative of current operation of the system. The method may comprise comparing the current signature to the predefined signatures to determine whether there is an anomalous event in the system. The comparison step may comprise applying the Bloom filter to the current signature.

If a match is obtained upon applying the Bloom filter to the current signature, then the method may comprise outputting a control action for the system.

The predefined signatures may each indicative of a critical anomalous event in the system. The control action may comprise one or more of: automatically stopping operation of the system; automatically switching operation to a backup system; and, transmitting an alert to a user.

The method may comprise defining a plurality of predefined second signatures each comprising a string of values and each being indicative of a non-critical anomalous event in the system. The method may comprise comparing the current signature to the predefined second signatures to determine whether there is a non-critical anomalous event in the system.

The method may comprise defining a second Bloom filter representing the plurality of predefined second signatures. The method may comprise comparing the current signature to the predefined second signatures comprises applying the second Bloom filter to the current signature.

If a match is obtained upon applying the second Bloom filter to the current signature, then the method may comprise outputting a control action for the system in dependence on the comparison.

The step of comparing the current signature to the predefined second signatures may be performed after the step of comparing the current signature to the predefined signatures.

The step of comparing the current signature to the predefined second signatures may be performed if no match is obtained upon applying the Bloom filter to the current signature. The step of comparing the current signature to the predefined second signatures may be performed if at least partial operation of the system continues after a control action performed after the step of comparing the current signature to the predefined signatures.

The system may comprise a plurality of subsystems. The method may comprise defining a subsystem Bloom filter for each of the plurality of subsystems. Each subsystem Bloom filter may represent a plurality of predefined signatures each comprising a string of values and each being indicative of an anomalous event in the respective subsystem. The Bloom filter may be defined by merging the plurality of subsystem Bloom filters.

If a match is obtained upon applying the Bloom filter to the current signature, then the method may comprise outputting a control action to automatically stop operation of the system.

After the step of automatically stopping operation of the system, the method may comprise applying each of the subsystem Bloom filters to the current signature in sequence to determine whether there is an anomalous event in one or more of the subsystems.

For each of the plurality of subsystems, if no match is obtained upon applying the respective subsystem Bloom filter to the current signature, then the method may comprise automatically restarting operation of the respective subsystem.

For each of the plurality of subsystems, if a match is obtained upon applying the respective subsystem Bloom filter to the current signature, then the method may comprise individually comparing each of the predefined signatures indicative of an anomalous event in the respective subsystem to the current signature.

For each of the plurality of subsystems, if no match is obtained from the individual comparison step, then the method may comprise automatically restarting operation of the respective subsystem.

For each of the plurality of subsystems, if a match is obtained from the individual comparison step, then the method may comprise outputting a control action for the system. The control action may comprise at least one of: automatically switching operation to a backup subsystem; and, transmitting an alert to a user.

The predefined signatures may each indicative of a critical anomalous event in one or more of the plurality of subsystems.

After the step of applying each of the subsystem Bloom filters to the current signature, the method may comprise, for each of the plurality of subsystems, defining a plurality of predefined second signatures each comprising a string of values and each being indicative of a non-critical anomalous event in the respective subsystem. The method may comprise, for each of the plurality of subsystems, comparing the current signature to the predefined second signatures of the respective subsystem to determine whether there is a non-critical anomalous event in the respective subsystem.

The method may comprise, for each of the plurality of subsystems, defining a second subsystem Bloom filter representing the plurality of predefined second signatures in the respective subsystem. Comparing the current signature to the predefined second signatures may comprise applying the respective second subsystem Bloom filter to the current signature.

For each of the plurality of subsystems, if a match is obtained upon applying the respective second subsystem Bloom filter to the current signature, then the method may comprise individually comparing each of the predefined signatures indicative of a non-critical anomalous event in the respective subsystem to the current signature.

For each of the plurality of subsystems, if a match is obtained from the individual comparison step, then the method may comprise outputting a control action for the system. The control action may comprise at least one of: automatically stopping operation of the respective subsystem; automatically switching operation to a backup subsystem; and, transmitting an alert to a user.

Determining the current signature may comprise assigning a value to the sensor data from each of the plurality of sensors.

Determining the current signature may comprise concatenating the sensor data from each of the plurality of sensors to obtain a concatenated sensor data string.

Determining the current signature may comprise applying a function to the concatenated sensor data string to obtain the current signature. The function may reduce a length of the concatenated sensor data to obtain the string of values of the current signature.

The function may be a fast hashing function.

The plurality of sensors may include electrical sensors. Optionally, the electrical sensors may include current and/or voltage sensors. The plurality of sensors may include mechanical sensors. Optionally, the mechanical sensors may include speed sensors. The plurality of sensors may include pressure sensors. The plurality of sensors may include environmental sensors, e.g. weather sensors such as temperature or humidity sensors.

The system may be an electrical system. The system may be a power generation system. The system may be a nuclear power plant, a wind turbine power plant, a hydropower plant, etc.

According to another aspect of the present invention there is provided a non-transitory, computer-readable storage medium storing instructions thereon that when executed by a processor cause the processor to perform a method as defined above.

According to another aspect of the present invention there is provided a controller for controlling operation of a system. The controller may be configured to define a Bloom filter representing a plurality of predefined signatures each comprising a string of values and each being indicative of an anomalous event in the system. The controller may be configured to receive sensor data, from a plurality of sensors of the system, indicative of a plurality of operational parameters associated with the system. The controller may be configured to determine, based on the received sensor data, a current signature comprising a string of values and being indicative of current operation of the system. The controller may be configured to compare the current signature to the predefined signatures to determine whether there is an anomalous event in the system. The comparison may comprise applying the Bloom filter to the current signature. The controller may be configured to output a control action for the system in dependence on the comparison.

### BRIEF DESCRIPTION OF THE DRAWINGS

Examples of the invention will now be described with reference to the accompanying drawings, in which:

FIG. 1 schematically illustrates a system and a controller in accordance with an example of the invention;

FIG. 2 illustrates how sensor data associated with operation of the system of FIG. 1 is processed by the controller of FIG. 1 to obtain a signature of a string of values;

FIG. 3 illustrates steps of a method performed by the controller of FIG. 1.

### DETAILED DESCRIPTION

The present invention relates to systems that provide services, such as critical services, e.g. power generation or distribution systems. Particularly for critical services, the time during which such systems are unavailable needs to be minimised. Possible system failures need to be detected in a timely and reliable manner. For instance, in a system that includes a number of subsystems, a failure in one of the subsystems (e.g. component/equipment failure or malfunction) may spread to other subsystems if not acted upon in a timely manner. This can increase the time and/or cost associated with repairs and reduce an overall availability of the system. The one or more subsystems in which failures are present or likely, need to be isolated relatively quickly.

Failures in a system or a subsystem can also cause safety issues in certain applications. For instance, in an example in which the system under consideration is a power conversion unit, its failure may cause unsafe voltage and current levels at its output, which could cause safety issues such as overheating or fires. In an example in which the system is a natural gas distribution system, for instance, a failure may cause the release of excess quantities of gas, resulting in an increased risk of explosion.

System failures may be detected or predicted by way of detecting anomalies in sensor data associated with a system. In particular, if anomalies are present in the system sensor data then this may indicate that the system or particular subsystem has failed or is in the process of failing. If complete failure has not occurred already, stopping operation of the system or subsystem can help to minimise the repair time and/or costs. However, in complex systems, anomalies are difficult to identify because the high number of components present and the complex interdependencies between them and their operation.

The present invention is advantageous in that it provides an approach for automatically detecting anomalies—or anomalous events—in a system (e.g. including different components, such as electrical components) that balances the need for relatively quick anomaly detection and action with the need to ensure the detection is accurate and action to stop operation of part or all of the system is taken only when necessary, e.g. when a critical failure is imminent, so as to maintain availability of the system where possible. These advantageous effects are achieved via the use of a Bloom filter, which allows for very fast detection of when an anomaly may be present in the system based on sensor data. The specific way in which this allows for the advantageous effects to be achieved will become apparent in the following description of specific examples that are in accordance with the invention.

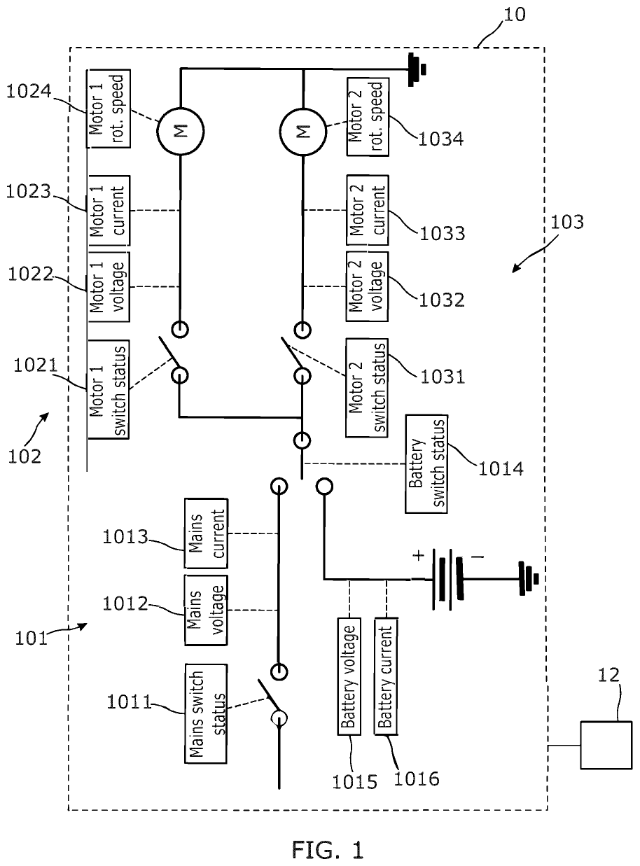

FIG. 1 schematically illustrates an example of a system 10 in which the anomaly detection approach of the present invention may be applied. In the illustrated example, the system 10 is an electrical system including two motors M that may be driven by mains or battery power. In this specific example, the two motors M are arranged on parallel branches of the electrical circuit.

The system 10 may in some examples be regarded as being a combination of subsystems 101, 102, 103 that together form the system 10. In the illustrated example, a first subsystem 101 includes components of the system 10 that relate to power supply, a second subsystem 102 includes components of the system 10 associated with the branch in which a first one of the motors M is located, and a third subsystem 103 includes components of the system associated with the branch in which a second one of the motors M is located.

The first subsystem (or power supply subsystem) 101 includes a mains power switch for connecting the circuit to mains power. The power supply subsystem 101 also includes a battery and a battery switch for switching the circuit power source between mains power and battery power. The power supply subsystem 101 includes a number of sensors for monitoring certain operational parameters associated with this subsystem 101. In particular, the subsystem 101 includes a sensor 1011 for monitoring a status (i.e. ON/OFF, or equivalent) of the mains power switch, and sensors 1012, 1013 for monitoring or measuring the voltage and current in the mains power branch of the circuit. The subsystem 101 also includes a sensor 1014 for monitoring the status of the battery switch, and sensors 1015, 1016 for monitoring the voltage and current in the battery power branch of the circuit.

The second subsystem 102 includes a switch for connecting the branch including the first motor M to the power supply. The second subsystem 102 also includes a number of sensors for monitoring certain operational parameters associated with this subsystem 102. In particular, the subsystem 102 includes a sensor 1021 for monitoring the status of the switch in this branch, sensors 1022, 1023 for monitoring the voltage and current in this branch, and a sensor 1024 for measuring the rotational speed of the first motor M. The third subsystem 103 includes corresponding components and sensors to the second subsystem 102, with the sensors being labelled 1031-1034 as shown in FIG. 1.

FIG. 1 also shows a controller 12 for controlling operation of the system 10. In particular, the controller 12 is configured to receive sensor data from the various sensors of the system 10, and is configured to output control actions for controlling the system 10, e.g. actuating the switches of the system between ON and OFF states, as required. The controller 12 may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods to be performed by the controller, and the processor(s) may execute the stored instructions to perform the methods.

The controller 12 is for monitoring the system 10 and for performing anomaly detection based on data acquired by the system sensors. An anomaly in the sensor data may correspond to certain values of sensor data, or certain combinations of such values, that are indicative of, or associated with, abnormal or improper operation of one or more parts of the system 10. A particular anomaly in the sensor data, e.g. a particular combination of sensor values, may be indicative of a certain issue associated with operation of part or all of the system 10. Certain anomalies may be associated with there being a greater likelihood of (imminent) failure of one or more components or parts of the system 10.

It may be known a priori which sensor values or combinations of values constitute, or are indicative of, an anomaly in a system. This information may be obtained in any suitable manner, for instance by monitoring one or more systems over time and associating certain sensor readings with certain events experienced by the system (or similar systems), e.g. failure of one or more system components. In this way, the anomalies that are to be detected as part of an approach in accordance with the present invention are known anomalies, or predefined anomalies.

A challenge exists in how to compare current or real-time sensor data obtained from the system sensors against sensor data associated with the various known anomalies, in particular where the comparison needs to be performed relatively quickly, e.g. in a time of the order of milliseconds. This may be especially challenging when there are a relatively large number of known anomalies to be checked, and where a relatively large amount of sensor data is available (which is often the case in large, complex systems).

With a view to how this comparison is performed in the described example, each of the known anomalies for the system 10 may be represented as a string of values, referred to as a signature, that are indicative of the respective anomaly or anomalous event. Some processing or filtering steps to obtain the predefined signatures—representing the known anomalies—from the sensor data associated with said known anomalies may be needed. This process may be referred to as quantising the sensor data.

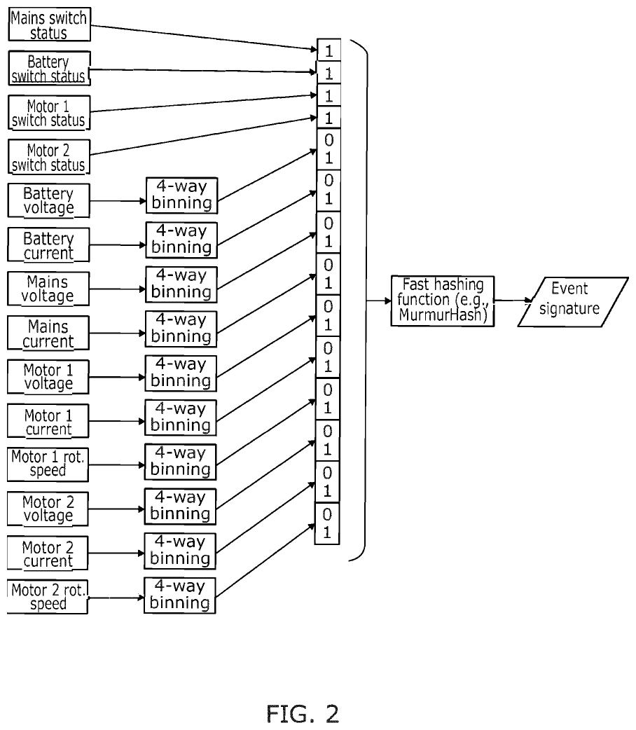

FIG. 2 schematically illustrates processing steps that may be performed to data obtained from the various sensors of the system 10 that is associated with certain anomalous events to obtain the predefined signature strings associated therewith. The obtained sensor data may take different forms depending on the type of sensor being considered. For instance, different types of sensors may output data as a binary, categorical, or continuous output, or any other suitable type of output. In one example, quantising the sensor output data may involve assigning certain ranges of sensor output values to bins, and then representing a value by the number of its bin (i.e. a ‘binning’ process').

In the example illustrated in FIG. 2, it is shown that the sensors monitoring the status of the various switches of the system 10 have a binary output, and so can be used directly. On the other hand, the sensors monitoring the voltage, current and motor speed provide an output that is then binned as described above. In the illustrated example, the voltage, current and speed values are binned using 4 bins, where the ranges assigned to each bin may be different for different sensors. Depending on the type of sensors being used in a given system, quantising the data may not be needed.

FIG. 2 illustrates that the data obtained from the various system sensors—some of which may have been quantised—is then concatenated to form a string of values. The resulting string may be relatively long, particularly if a large number of sensors is being used to provide data. Long strings of values can take a relatively long time to search, which may be unsuitable where relatively quick processing is needed, such as in examples of the present invention. As such, the strings may be further processed to reduce their length—so that they may queried more quickly—while retaining the information contained therein. In particular, the string of sensor data may be hashed to reduce its length. This hashed string may then constitute the predefined signature for each anomaly.

It will be understood that the predefined signatures will preferably simply be provided to the system 10 and controller 12, and that the process illustrated in FIG. 2 does not need to be performed for known anomalies. As will be described below, however, the process of FIG. 2 may be applied to sensor data collected in real-time during an anomaly detection process.

Each predefined signature may be associated with one or more of the subsystems 101, 102, 103 of the system 10. That is, certain known anomalies may be associated with certain parts of the system 10. However, it is noted that each defined signature may include data from all of the sensors in the system (as illustrated in FIG. 2), and not just sensors from the subsystem to which a particular anomaly is associated. This enables the identification of anomalies in a particular subsystem by also making use of the sensors in other subsystems (e.g. downstream of the particular subsystem) of the system. For instance, in the described example an anomalous voltage in both of the two motors M may indicate an issue in the power supply subsystem 101. Furthermore, the creation of a single (current) signature is faster than creating multiple signatures (e.g. one for each subsystem), and so this may be beneficial in which fast detection is needed.

The predefined signatures indicative of the different known anomalies that may be present in a system may be further categorised. For instance, different anomalies may have different levels of severity in terms of their potential impact on the operation of the system 10. Some anomalies may indicate imminent failure of one or more system components may be likely, and may be likely to cause failures across different parts of the system. Such anomalies may for instance be regarded as critical anomalies, where certain action is needed to guard against system failure when they are detected. On the other hand, different anomalies may indicate that a certain part of the system is not operating optimally, but does not necessarily pose a risk to overall operation of the system or is unlikely to result in system failure. Such anomalies may be regarded as non-critical anomalies, where a different type of action in response to their presence relative to more critical anomalies may be appropriate. It will be understood that different types of known anomalies could be categorised in different ways, and into different numbers of categories, as appropriate.

The invention provides a method for monitoring a system, e.g. in real time, to detect the presence of anomalies in the system relative to the predefined, known anomalies. The invention in particular allows for this detection to be performed quickly so that action in response to any such detection may be taken as appropriate.

Referring to the example illustrated in FIG. 1, the controller 12 receives sensor data from each of the sensors 1011-1016, 1021-1024, 1031-1034 indicative of current values of the various operational parameters of the system 10, e.g. voltage, electrical current, switch status, etc. In order that the current values of sensor readings may be checked for anomalies, the received sensor data is processed to create a current signature—i.e. a signature relating to, or representative of, the present time—comprising a string of values indicative of the current operation of the system 10, e.g. as illustrated in FIG. 2. As described above, in order to obtain a signature of reduced length, a hashing function may be used. As short processing times are required by certain applications envisioned for the described approach, where the detection process needs to be performed quickly, a fast hashing function (a non-cryptographic hash function) may be used to obtain the current signature. For instance, the known MurmurHash function may be used for this purpose.

Once the current signature has been obtained, this may be used to check whether there are any anomalies currently present in the system 10. As mentioned above, the present invention advantageously uses Bloom filters to perform this check or comparison against known anomalies. Bloom filters are probabilistic data structures that can be used to determine whether an element is in a set. In the present invention, a Bloom filter is used to determine whether a (current) signature derived from sensor data corresponds to one of the pre-recorded or predefined signatures indicative of known anomalies that may arise in a system. Bloom filters benefit from being very fast to execute/run, and are therefore appropriate in the present context where fast anomaly detection is needed.

One feature of Bloom filters is that may include false positives, but do not provide false negatives. That is, if an element is indeed in a set, then a Bloom filter will always correctly identify the element as being part of the set. However, if an element is not part of a set, then a Bloom filter may incorrectly identify the element as being part of the set. This means that, if a Bloom filter indicates a match for a particular element—i.e. the Bloom filter identifies the element as being in a set—then further analysis needs to be performed to finally or conclusively determine whether the element is in fact in the set.

In more detail, a Bloom filter represents a set of elements using a bit vector of defined length. Each of the bits in the bit vector are initialised to zero. To insert an element from the set into the bit vector, a group of independent hash functions may be used to randomly map the element into certain positions of the bit vector. The bits in these certain positions are then set to one. To query whether an arbitrary element is a member of the set, the Bloom filter maps the element into its bit vector with the above-mentioned hash functions and then checks whether all of the bits to which the element is mapped are ones. If any bit of the hashed positions of the arbitrary element is zero, then the Bloom filter concludes that the arbitrary element is not part of the set. Otherwise, the Bloom filter indicates that the arbitrary element is part of the set.

In the example illustrated in FIG. 1, a Bloom filter may be created for each of the subsystems 101, 102, 103 of the system 10. Each of these subsystem Bloom filters may be populated with the predefined signatures associated with the respective subsystem, as outlined above. A single, overall Bloom filter for the system 10 may then be created from the subsystem Bloom filters. A property of Bloom filters is that multiple Bloom filters can be merged to create a single Bloom filter. The merged Bloom filter is therefore equivalent to a Bloom filter built or created on the union of sets (groups of predefined signatures) from which each Bloom filter has been created. This property of Bloom filters can therefore be leveraged to compare a current signature against a Bloom filter created from the merging of subsystem Bloom filters from each of the subsystems 101, 102, 103.

As more elements or items are added to a Bloom filter, the probability of false positives increases. Therefore, the approach of the present invention needs to balance speed of detection with detection accuracy. For instance, the detection of critical anomalies in a system may be more time sensitive than the detection of non-critical anomalies, as it may be more important that the development of critical anomalies are responded to more quickly.

For the example illustrated in FIG. 1, a (first) Bloom filter may be defined that is for detecting critical anomalies in the system 10. This Bloom filter may be defined by merging together a subsystem Bloom filter defined for each respective subsystem 101, 102, 103, where each subsystem Bloom filter is for detecting critical anomalies in the respective subsystem 101, 102, 103. That is, the (first) Bloom filter is for checking the current signature against the union of critical anomalies in the system, i.e. union of predefined signatures associated with critical anomalies. Application of a single filter in this manner to check the current signature against all possible critical anomalies allows for fast detection of when a critical anomaly may be present.

If a match is found when the Bloom filter is applied to the current signature in the controller 12, then this indicates that a critical anomaly may be present. The controller 12 may perform a control action based on this determination. As an anomaly of a critical nature is deemed to possibly be present in the system 10, but at an unknown location (i.e. it is unknown in which subsystem 101, 102, 103 the anomaly may be), then the controller 12 may output a control action to stop operation of the entire system 10. This provides a fast reaction to prevent the possible development of a critical fault that could spread throughout the system 10, for instance. In this way, the response time between an anomaly occurring and operation of the system 10 being stopped to prevent issues of a potentially critical nature (e.g. safety issues) is the time to execute only one comparison operation, which is an improvement on previous approaches.

In the case in which a match is found, further processing may be performed to determine in which subsystem 101, 102, 103 the critical anomaly may be. This may involve applying each of the subsystem Bloom filters associated with each respective subsystem 101, 102, 103 individually in sequence to the current signature. For each subsystem Bloom filter, if no match is found then it can be concluded that no critical anomaly is present in the respective subsystem 101, 102, 103. As such, the controller 12 may output a control action to restart operation of said respective subsystem 101, 102, 103.

On the other hand, if a match is found for a particular subsystem Bloom filter, then this indicates that a critical anomaly may be present in the respective subsystem 101, 102, 103. In this case, the current signature may be checked against each predefined signature for critical anomalies associated with that particular subsystem. If the current signature matches one of these predefined signatures then it may be ultimately concluded that a critical anomaly is indeed present in the particular subsystem, in which case operation of the particular subsystem may remain stopped until the issue can be investigated and resolved. The controller 12 may for instance send an alert to a user informing them of the critical anomaly, log the anomaly in a database associated of the system, and/or output a control action to switch to a backup or alternative subsystem, if available. If the current signature does not match one of the predefined signatures then it may be ultimately concluded that there is actually no critical anomaly in the particular subsystem 101, 102, 103 being investigated. As such, the controller 12 may automatically restart operation of said subsystem.

With continuing reference to the example illustrated in FIG. 1, once the current signature has been checked against the possible critical anomalies in the above manner, then a consideration of possible non-critical anomalies may follow. The detection of non-critical anomalies may be less time sensitive than for critical anomalies, in which case a different detection method may be used for non-critical anomaly detection, e.g. a method that prioritises accuracy over time to a greater extent than the above-described critical anomaly detection method based on Bloom filters. It will be understood, however, that the relative importance of accuracy and detection time can vary between different systems.

In one example, a second Bloom filter may be defined that is for detecting non-critical anomalies in the system 10. The second Bloom filter may be applied after the analysis of the critical anomalies, and may only be performed if one or more of the subsystems remain operational after the critical anomaly analysis. In a corresponding manner to the consideration of critical anomalies above, the second Bloom filter may be defined by merging together a (second) subsystem Bloom filter defined for each respective subsystem 101, 102, 103, where each second subsystem Bloom filter is for detecting non-critical anomalies in the respective subsystem 101, 102, 103. Similarly to the above in relation to critical anomalies, if a match is found when the second Bloom filter is applied to the current signature in the controller 12, then this indicates that a non-critical anomaly may be present in the system 10. Each of the second subsystem Bloom filters may then be applied to identify in which subsystem 101, 102, 103 the non-critical anomaly is present. When a particular one of the second subsystem Bloom filters identifies a match, the controller 12 may compare each predefined signature associated with a non-critical anomaly of that particular subsystem with the current signature to check both if a non-critical anomaly is present, and what type of anomaly is present. In case of a match being found, the controller 12 may output an appropriate control action/signal, e.g. stop operation of the particular subsystem 101, 102, 103, switch operation to an available backup subsystem, log the anomaly in a database associated of the system 10, and/or generate an alert for a user of the system 10.

In another example, if very low detection time is less of a priority for non-critical anomalies, then a single, unifying second Bloom filter for the entire system 10 may not be used, and instead the analysis of non-critical anomalies may proceed straight to applying each of the second subsystem Bloom filters associated with each respective subsystem 101, 102, 103 individually in sequence to the current signature. In a further example where detection time is less of a priority for non-critical anomalies, then the current signature may simply be checked individually against each predefined signature for non-critical anomalies associated with the system 10. In short, for non-critical anomalies the availability of the system 10 (i.e. operation of the system 10) may be prioritised over the response time to halt an affected system when compared to the approach taken for critical anomalies.

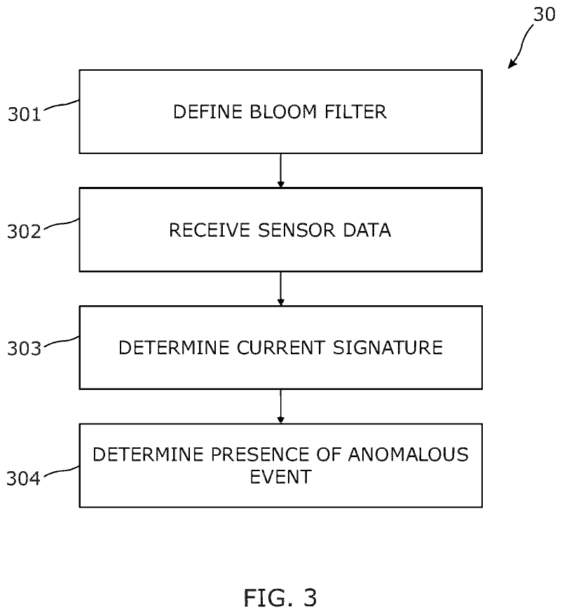

FIG. 3 summarises the steps of a method 30 to be performed by the controller 12 of the system 10 in accordance with an example of the invention. At step 301, a (first) Bloom filter is defined that represents a plurality of predefined signatures each comprising a string of values and each being indicative of an anomaly or anomalous event in the system 10. The predefined signatures represent known anomalies that may arise in a given system, and for which appropriate signatures in the form of strings of values have been predetermined from appropriate sensor data (e.g. historical data).

As in the example described above, the Bloom filter may be defined by merging a plurality of (subsystem) Bloom filters each representing anomalies associated with different defined subsystems of the overall system. However, in different examples the system may considered as a whole and a single (first) Bloom filter may be defined to represent anomalies across the entire system.

Also as in the example described above, if different categories of anomalies are defined, e.g. where the importance of anomaly detection timing and detection accuracy is different between the different categories, then a Bloom filter may be defined for anomaly detection in each category. For instance, a first Bloom filter may be used to detect anomalies in a ‘critical’ category, and a second Bloom filter may be used to detect anomalies in a ‘non-critical’ category. It will be understood any suitable number of anomaly categories may be defined.

At step 302 of the method 30, sensor data is received from a plurality of sensors of the system. The sensor data is indicative of a plurality of operational parameters associated with the system. These parameters depend on the type of system under consideration, and can include inputs to the system, outputs from the system, states of the system, etc. If the system is an electrical system including electrical circuit components, the operational parameters may include voltage, current, switch states, power, load values, etc. However, it will be understood that any suitable types of operational parameters may be considered. For instance, parameters based on the outputs of pressure sensors, temperature sensors, humidity sensors, etc. may be used in different systems. The system could be a power generation system, such as a wind, hydro, or nuclear power plant.

At step 303 of the method 30, a current signature is determined based on the received sensor data. The current signature is a string of values and is indicative of current operation of the system under consideration. To obtain the current signature from the sensor data, data from at least some of the sensors may need to be quantised so as to assign a value to the received data, e.g. by a binning process. The string of values from the sensor data may be processed by a fast hashing function to reduce its length, and the current signature may be this reduced-length string of values indicative of the received sensor data.

At step 304 of the method 30, the current signature is compared to the predefined signatures to determine whether there is an anomalous event in the system. In particular, this comparison comprises applying the defined Bloom filter to the current signature. If the Bloom filter provides a match then this indicates that an anomaly may be present in the system. In this case, further processing may be performed to ascertain this. In a case in which the Bloom filter is a merger of a plurality of subsystem Bloom filters then each of these may be applied to the current signature to identify in which subsystem an anomaly may be present. After application of the Bloom filter—or subsystem Bloom filters—the current signature may be checked individually against the relevant predefined signatures of the system or appropriate subsystem to conclude whether an anomaly is indeed present.

In the case that an anomaly is determined to be present, the controller 12 may perform an appropriate control action in response. This control action may depend on which category of anomaly is found to be present (critical, non-critical, etc.). The control actions may include halting operation of the system or relevant subsystem, generate user alerts, switching to backup systems or subsystems, logging the anomaly in a database, etc.

Steps 302, 303 and 304 may be repeated at a suitable frequency to substantially continuously monitor the development of anomalies in the system.

Many modifications may be made to the described examples without departing from the scope of the appended claims.

1. A computer-implemented method for determining an anomalous event in a system, the method comprising:
defining a Bloom filter representing a plurality of predefined signatures each comprising a string of values and each being indicative of an anomalous event in the system;
receiving sensor data, from a plurality of sensors of the system, indicative of a plurality of operational parameters associated with the system;
determining, based on the received sensor data, a current signature comprising a string of values and being indicative of current operation of the system; and,
comparing the current signature to the predefined signatures to determine whether there is an anomalous event in the system, the comparison comprising applying the Bloom filter to the current signature.

2. The method according to claim 1, wherein the predefined signatures are each indicative of a critical anomalous event in the system, and wherein if a match is obtained upon applying Bloom filter to the current signature, then the method comprises outputting a control action for the system, the control action comprising one or more of:
automatically stopping operation of the system;
automatically switching operation to a backup system; and,
transmitting an alert to user.

3. (canceled)

4. The method according claim 1, the method comprising:
defining a plurality of predefined second signatures each comprising a string of values and each being indicative of a non-critical anomalous event in the system; and,
comparing the current signature to the predefined second signatures to determine whether there is a non-critical anomalous event in the system.

5. The method according to claim 4, the method comprises defining a second Bloom filter representing the plurality of predefined second signatures, wherein comparing the current signature to the predefined second signatures comprises applying the second Bloom filter to the current signature.

6. The method according to claim 5, wherein if a match is obtained upon applying the second Bloom filter to the current signature, then the method comprises outputting a control action for the system in dependence on the comparison.

7. The method according to claim 4, wherein the step of comparing the current signature to the predefined second signatures is performed after the step of comparing the current signature to the predefined signatures.

8. The method according to claim 4, wherein the step of comparing the current signature to the predefined second signatures is performed if:
no match is obtained upon applying the Bloom filter to the current signature; or,
at least partial operation of the system continues after a control action performed after the step of comparing the current signature to the predefined signatures.

9. The method according to claim 1, wherein the system comprises a plurality of subsystems, the method comprising defining a subsystem Bloom filter for each of the plurality of subsystems, each subsystem Bloom filter representing a plurality of predefined signatures each comprising a string of values and each being indicative of an anomalous event in the respective subsystem, and wherein the Bloom filter is defined by merging the plurality of subsystem Bloom filters.

10. The method according to claim 9, wherein if a match is obtained upon applying the Bloom filter to the current signature, then the method comprises outputting a control action to automatically stop operation of the system, and, after the step of automatically stopping operation of the system, the method comprises applying each of the subsystem Bloom filters to the current signature in sequence to determine whether there is an anomalous event in one or more of the subsystems.

11. (canceled)

12. The method according to claim 10, wherein, for each of the plurality of subsystems, if no match is obtained upon applying the respective subsystem Bloom filter to the current signature, then the method comprises automatically restarting operation of the respective subsystem.

13. The method according to claim 10, wherein, for each of the plurality of subsystems, if a match is obtained upon applying the respective subsystem Bloom filter to the current signature, then the method comprises individually comparing each of the predefined signatures indicative of an anomalous event in the respective subsystem to the current signature.

14. The method according to claim 13, wherein, for each of the plurality of subsystems, if no match is obtained from the individual comparison step, then the method comprises automatically restarting operation of the respective subsystem.

15. The method according to claim 13, wherein, for each of the plurality of subsystems, if a match is obtained from the individual comparison step, then the method comprises outputting a control action for the system, wherein the control action comprises at least one of:
automatically switching operation to a backup subsystem; and,
transmitting an alert to a user.

16. (canceled)

17. The method according to claim 9, wherein after the step of applying each of the subsystem Bloom filters to the current signature, the method comprises, for each of the plurality of subsystems:
defining a plurality of predefined second signatures each comprising a string of values and each being indicative of a non-critical anomalous event in the respective subsystem;
defining a second subsystem Bloom filter representing the plurality of predefined second signatures in the respective subsystem, and
comparing the current signature to the predefined second signatures of the respective subsystem to determine whether there is a non-critical anomalous event in the respective subsystem, wherein comparing the current signature to the predefined second signatures comprises applying the respective second subsystem Bloom filter to the current signature.

18. (canceled)

19. The method according to claim 17, wherein, for each of the plurality of subsystems, if a match is obtained upon applying the respective second subsystem Bloom filter to the current signature, then the method comprises individually comparing each of the predefined signatures indicative of a non-critical anomalous event in the respective subsystem to the current signature, and if a match is obtained from the individual comparison step, then the method comprises outputting a control action for the system, wherein the control action comprises at least one of:
automatically stopping operation of the respective subsystem;
automatically switching operation to a backup subsystem; and,
transmitting an alert to a user.

20. (canceled)

21. The method according to claim 1, wherein determining the current signature comprises assigning a value to the sensor data from each of the plurality of sensors.

22. The method according to claim 1, wherein determining the current signature comprises concatenating the sensor data from each of the plurality of sensors to obtain a concatenated sensor data string.

23. The method according to claim 22, wherein determining the current signature comprises applying a function to the concatenated sensor data string to obtain the current signature, wherein the function reduces a length of the concatenated sensor data to obtain the string of values of the current signature.

24-26. (canceled)

27. A non-transitory, computer-readable storage medium storing instructions thereon that when executed by a processor cause the processor to perform a method according to claim 1.

28. A controller for controlling operation of a system, the controller being configured to:
define a Bloom filter representing a plurality of predefined signatures each comprising a string of values and each being indicative of an anomalous event in the system;
receive sensor data, from a plurality of sensors of the system, indicative of a plurality of operational parameters associated with the system;
determine, based on the received sensor data, a current signature comprising a string of values and being indicative of current operation of the system; and,
compare the current signature to the predefined signatures to determine whether there is an anomalous event in the system, the comparison comprising applying the Bloom filter to the current signature, and output a control action for the system in dependence on the comparison.
